(19) United States
(12) Patent Application Publication
(10) Pub. No.: US 2004/0245749 A1
(43) Pub. Date: Dec. 9, 2004

(54) Sealing device for the interface between an airbag and a gas generator

(75) Inventor: Stephane Goujon, Les Damps (FR)

Correspondence Address: CASELLA & HESPOS, 274 MADISON AVENUE, NEW YORK, NY, 10016

(73) Assignee: AERAZUR S.A.S.U., ISSY LES MOULINEAUX (FR)

(21) Appl. No.: 10/851,852

(22) Filed: May 21, 2004

(30) Foreign Application Priority Data
May 22, 2003 (FR) 03 06126

(51) Int. Cl. B60R 21/16

(52) U.S. Cl. 280/728.2

(57) ABSTRACT

Sealing device for the interface between an airbag and a gas generator. A flat seal (7) made of an elastomer material is fixed by stitching (9) to the piece of cloth (5), constituting an interface, which is stitched to the wall of the airbag (4). The seal (7) has a circular opening at its center, which faces the opening presented by the interface (5). The diameter of the opening (7) is less than the outside diameter of the end (1) of the gas generator and the insertion of this end (1) into the opening (7) causes the formation of a flap formed by the edge of the seal (7), which acts as a sealing lip. The invention ensures an increase in pressure in the airbag and improves the shock absorbance offered to the occupant of the vehicle.

### BACKGROUND OF THE INVENTION

1. Field of the Invention

The present invention relates to airbags fitted to motor vehicles. The subject of the invention is more particularly the sealing between the gas generator and the airbag.

2. Description of the Related Art

In conventional airbag systems, the end of the gas generator is inserted into an opening in the airbag at the place of an interface made from a piece of cloth stitched to the wall of the airbag. This interface is generally a source of leaks owing to the nature of the materials in contact with each other, that is to say the cloth of the interface and the metal of the gas generator. These gas losses have the effect of reducing the pressure inside the airbag and therefore reducing the shock absorbance offered to the occupant of the vehicle in the event of an accident.

### SUMMARY OF THE INVENTION

The object of the present invention is to remedy the abovementioned drawbacks of the conventional airbag systems and proposes for this purpose a sealing device for the interface between an airbag and a gas generator that makes it possible to reduce the gas losses between the generator and the airbag, increasing the pressure in the airbag and improving the shock absorbance offered to the occupant of the vehicle.

According to the invention, the sealing device for the interface between an airbag and a gas generator, this interface consisting of a piece of cloth fixed to the wall of the airbag and having an opening for the insertion of the end of the gas generator, is one which comprises a seal made of an elastomer material that has an opening at its center, the outline of said opening having a length not exceeding the external outline of said end of the generator, said seal being fixed to said interface so that its opening faces said opening in the interface.

Advantageously, the seal according to the invention is flat and is fixed to the interface by stitching. In one advantageous embodiment, the seal is made of silicone.

When the end of the gas generator is of circular cross section, the hole in the seal according to the invention then has a diameter not exceeding the outside diameter of the end of the generator.

It will be understood that, when inserting the end of the generator, it is the extension of the diameter of the opening in the seal, which does not exceed the outside diameter of this end, which provides the sealing. Forcibly inserting the end of the generator into the airbag causes the formation of a flap, which acts as a lip toward the inside of the airbag.

It should be noted that the invention is, owing to its design, particularly simple to produce as it comprises only a single element to be added to the airbag. In addition, this element occupies only a very small space.

Since the seal according to the invention is made of an elastomer material, it can adapt perfectly to the shape of the gas generator. In addition, owing to its small size and its flexibility, the seal according to the invention does not impair the folding of the airbag.

The seal according to the invention makes it possible to retain all the gas inside the airbag, which is completely gas tight at the interface throughout the operation phase of the airbag.

It should also be noted that the seal may advantageously be made using a process for obtaining a very smooth surface finish without any visible defect, so that there is no rupture initiator in the region of the central hole.

In order to gain a clear understanding of the invention, a preferred embodiment thereof will be described hereinafter by way of a nonrestrictive example, with reference to the appended schematic drawing in which:

### BRIEF DESCRIPTION OF THE DRAWINGS

FIG. 1 is a schematic view in vertical section of the conventional fitting of a gas generator onto an airbag, without the use of the seal according to the invention.

FIG. 2 is a plan view of a seal according to the present invention.

FIG. 3 is a plan view of the interface region of an airbag equipped with the seal as shown in FIG. 2.

FIG. 4 is a schematic view in vertical section showing the fitting of the seal shown in FIGS. 2 and 3 onto the interface region of the airbag.

FIG. 5 is a view in vertical section similar to FIG. 1, but showing the fitting of a gas generator onto an airbag equipped with the seal as shown in FIGS. 2 to 4.

### DETAILED DESCRIPTION OF THE PREFERRED EMBODIMENTS

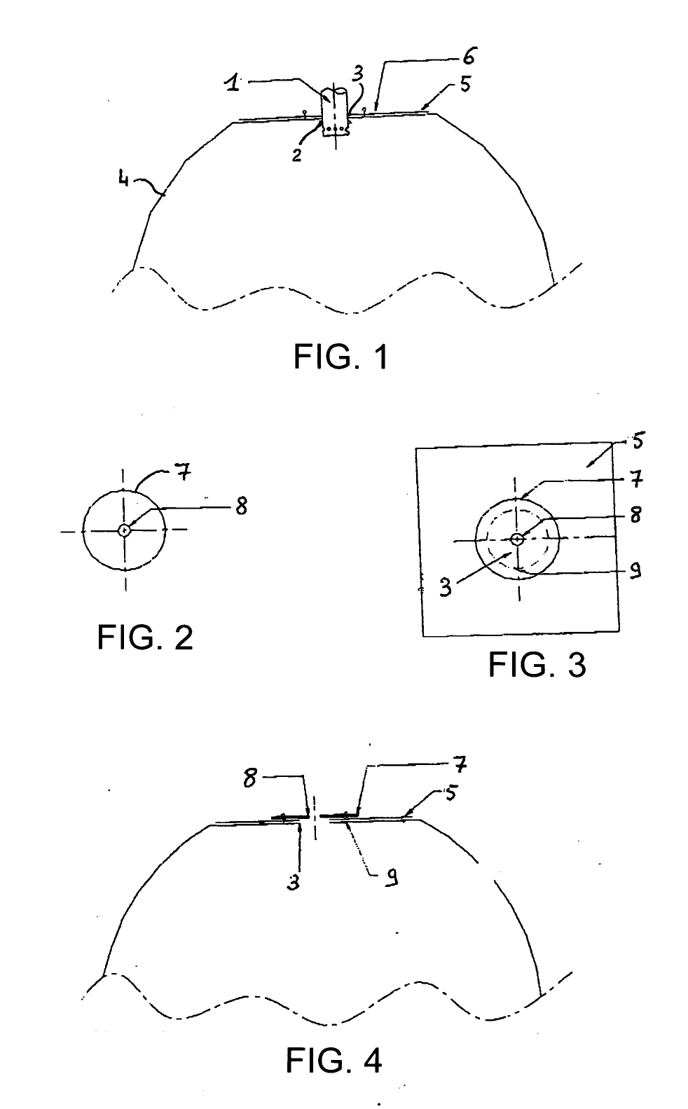

FIG. 1 shows the conventional fitting of the end 1 of circular cross section of a gas generator. For this purpose, the end 1 of the gas generator passes through the facing holes 2 and 3 made in the wall of the airbag 4 and in the interface 5 of the airbag respectively, said interface being formed by a piece of cloth stitched at 6 to the wall of the airbag. It will be understood that, during diffusion into the airbag 4 of the gas jets emanating from the radial openings in the end 1 of the generator, gas leaks occur in the interface region owing to the contacting between the metal of the generator 1 and the cloth of the interface 5.

FIG. 2 shows at 7 a seal according to the invention formed by a flat piece made of an elastomer material, i.e. silicone in the example described. The seal 7 has a hole 8 at its center, the diameter of said seal not exceeding the outside diameter of the end of the gas generator.

As may be seen in FIGS. 3 and 4, the seal 7 is fitted onto the interface 5 of the airbag 4 by placing the seal 7 on the cloth of the interface 5 in such a way that the hole 8 of the seal exactly faces the hole 3 made in the interface 5, and then by fixing the seal 7 in this position by stitching 9 for bonding them.

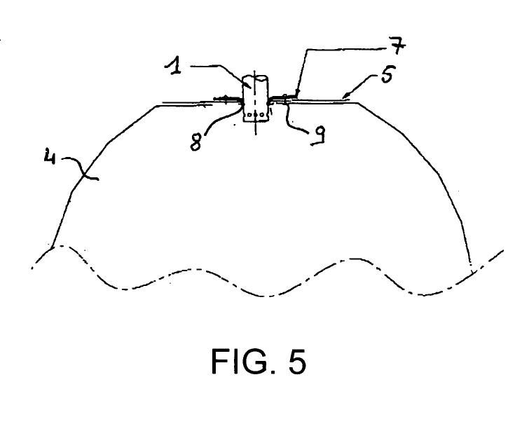

As shown in FIG. 5, when fitting the gas generator, forcibly inserting the end 1 of the generator through the hole 8 in the seal 7, toward the inside of the airbag 4, causes the diameter of the hole 8 to extend, which creates the sealing between the interface 5 and the part 1 of the generator. In addition, this insertion causes the formation of a flap formed by the edge of the seal 7, which acts as a lip toward the inside of the airbag, which further improves the sealing.

The operation of the seal 7 is therefore readily understood: with the airbag 4 folded in its case (not shown), the seal 7 is in its passive state and is not exposed to the pressure of the gases.

When an impact occurs, the first step that happens is the ignition of the system, which causes the diffusion of gas jets into the airbag 4 via the radial openings in the end 1 of the generator.

In a second step, the airbag 4 inflates and is deployed in expectation of the occupant penetrating the airbag.

Finally, in a third step, the occupant penetrates the airbag 4, which causes the pressure inside the airbag to rise up to its maximum.

The seal 7 helps to retain the gases inside the airbag 4 during the three steps.

It will be understood that the above description has been given simply as an example, but implying no restriction, and that constructional additions or modifications could be made thereto without departing from the scope of the present invention. Thus, it will be understood that the seal according to the invention was described as being intended to cooperate with a gas generator of circular cross section, but the seal could also cooperate with a gas generator of any other regular cross section, for example of square cross section.

What is claimed is:

1. A sealing device for an interface between an airbag (4) and a gas generator, said interface (5) comprising a piece of cloth fixed to a wall of the airbag (4) and having an interface opening (3) for insertion of an end (1) of the gas generator, said sealing device comprising a seal (7) made of an elastomer and having a seal opening (8) at its center, said seal opening defining an outline having a length not exceeding an external outline of said end (1) of the generator, said seal (7) being fixed to said interface (5) so that said seal opening (8) faces said interface opening (3) in the interface (5).

2. The sealing device of claim 1, wherein said seal (7) is flat.

3. The sealing device of claim 1, wherein said seal (7) is made of silicone.

4. The sealing device of claim 1, wherein said seal (7) is fixed to the interface (5) by stitching (9).

5. The sealing device of claim 1, wherein the gas generator has a circular cross section with an outside diameter, and wherein the seal opening (8) in the seal (7) has a diameter not exceeding the outside diameter of the gas generator.
